(19) United States
(12) Patent Application Publication
(10) Pub. No.: US 2012/0033604 A1
(43) Pub. Date: Feb. 9, 2012

(54) BASE STATION DEVICE, TERMINAL DEVICE, RADIO COMMUNICATION SYSTEM, TRANSMISSION METHOD, RECEPTION METHOD, AND PROGRAM

(76) Inventors: Isao Hirakawa, Osaka (JP); Toshizo Nogami, Osaka (JP); Yosuke Akimoto, Osaka (JP); Katsunari Uemura, Osaka (JP); Shohei Yamada, Osaka (JP); Shoichi Suzuki, Osaka (JP)

(21) Appl. No.: 13/265,102

(22) PCT Filed: Mar. 29, 2010
(86) PCT No.: PCT/JP2010/055595

§ 371 Date: Oct. 18, 2011

(30) Foreign Application Priority Data
Apr. 23, 2009 (JP) 2009-105371

(51) Int. Cl. H04W 4/06; H04W 72/04; H04W 52/04

(52) U.S. Cl. 370/312; 370/329

(57) ABSTRACT

A base station device, a terminal device to communicate with a base station device, and a transmission method are disclosed. The base station device includes an indicating part that indicates the availability of the coordinated communication. The base station device also includes a determining part that determines, in accordance with the availability of the coordinated communication, the ratio of the power of a data signal with respect to a transmission symbol including a reference signal to the power of a data signal with respect to a transmission symbol not including a reference signal.

### TECHNICAL FIELD

The present invention relates to a multi-carrier communication technique utilizing a radio communication technique, and, more particularly, to a power allocation technique for performing coordinated communication using a plurality of base stations, as well as to a notification technique thereof.

### BACKGROUND ART

Evolved third-generation radio access (Evolved Universal Terrestrial Radio Access, hereinafter referred to as “EUTRA”) and an evolved third-generation radio access network (Evolvde Universal Terrestrial Radio Access Network, hereinafter referred to as “EUTRAN”) are currently under consideration. There are also referred to as Long Term Evolution (LTE). Also, as an advanced form thereof, evolved Long Term Evolution (LTE-A: Long Term Evolution-Advanced) is under consideration.

A brief description of the content of the techniques used in LTE E and LTE-A is provided below.

### (1) Description Regarding the Downlink Radio Frame Structure of LTE and LTE-A

For the downlink of LTE and LTE-A, an OFDMA (Orthogonal Frequency Division Multiplexing Access) scheme is employed. Downlink radio channels in an OFDMA scheme are arranged multiplexed in time/frequency, through Time Division Multiplexing TDM, Frequency Division Multiplexing FDM, or a combination of TDM and FDM, by employing resources of the frequency axis (sub-carriers) and the time axis (OFDM symbols) of OFDM signals.

FIG. 6 is an example of a downlink radio frame structure for EUTRA proposed in 3GPP, and is a diagram showing an example of radio channel mapping with respect to four transmit antennas. The downlink radio frame shown in FIG. 6 is a group of multiple sub-carriers of the frequency axis (vertical axis) and comprises a frequency bandwidth Bch and symbols of the time axis (horizontal axis). As shown in the diagram, each slot comprises seven symbols, and two slots make up one sub-frame. A two-dimensional radio resource block comprises twelve sub-carriers×seven symbols, and two consecutive radio resource blocks along the time axis make up a resource block pair (RB pair), which is enclosed with bold lines in FIG. 6. Several such resource block pairs (RB pairs) are grouped together to form a radio frame. It is noted that the smallest unit comprising one sub-carrier and one OFDM symbol is referred to as a resource element.

By way of example, as shown in FIG. 6, with respect to the frequency axis, the spectrum of the downlink as a whole (the system frequency bandwidth Bch specific to each base station) is 20 MHz, one radio frame is 10 ms, and the sub-frame SF is 1 ms. Twelve sub-carriers and one sub-frame (1 ms) make up a resource block pair (RB pair). If the sub-carrier frequency bandwidth Bsc is defined as being 15 kHz, the frequency bandwidth Bch of the resource block would be 180 kHz (15 kHz×12), and 1200 sub-carriers would be contained in the downlink over the 20 MHz band as a whole. One radio frame contains 100 RBs.

In the case of four transmit antennas, when looked at as a whole, it can be seen that the first, fifth, eighth and twelfth OFDM symbols contain reference signals RS1 for the first antenna (Ant1) and reference signals RS2 for the second antenna (Ant2). In addition, reference signals RS3 for the third antenna and reference signals RS4 for the fourth antenna are similarly arranged in the second and ninth OFDM symbols. With respect to the resource elements in which there are no reference signals, data from the respective transmit antennas are multiplexed and transmitted. It is noted that radio channel mapping in the case of two transmit antennas would be as it is in FIG. 6 but with reference signals RS3 for the third antenna and reference signals RS4 for the fourth antenna removed, where data is transmitted instead. In addition, radio channel mapping in the case of one transmit antenna would be as it is in FIG. 6 but with reference signals RS2 for the second antenna, reference signals RS3 for the third antenna, and reference signals RS4 for the fourth antenna removed, where data is transmitted instead. (See Non-Patent Document 1 mentioned below).

### (2) The Power of the Sub-Carriers of Each Antenna

In EUTRA, a terminal device demodulates data signals based on reference signals. The power of a data signal can be calculated based on ratio ρA of data signal to reference signal that is individually notified from a base station device to each terminal device, and on the power of the reference signal that the terminal device receives. FIG. 7 is a figure showing the values of ρA defined in EUTRA (see Non-Patent Document 2 mentioned below).

In EUTRA, reference signals are not located in all OFDM symbols. In addition, only reference signals regarding some of the antennas is located in one OFDM symbol. Thus, there arises an imbalance in transmitted power among OFDM symbols and among antennas. In order to resolve this, data power values are differentiated between the power of a data signal with respect to an OFDM symbol that transmits a reference signal (referred to as type B) and a data signal with respect to an OFDM symbol that does not transmit a reference signal (referred to as type A). With respect to OFDM symbols that transmit a reference signal, by having a power from which the power of a reference signal has been subtracted be the power of the data signal (type B), power balance among the symbols is maintained (see Non-Patent Document 3 mentioned below). It is noted that the ρA values in FIG. 7 mentioned above are ratios of type A data signal to reference signal.

FIG. 10 is a figure showing such a concept. (a-1) in FIG. 10 is a figure schematically representing a reference signal and data signal power distribution with respect to the fifth OFDM symbol, which is an OFDM symbol in which there are reference signals for the case of one transmit antenna. In addition, (a-2) is a figure schematically representing a reference signal and data signal power distribution with respect to the sixth OFDM symbol, which is an OFDM symbol in which there is no reference signal. In the case of one transmit antenna, two reference signals and ten data signals are arranged in the fifth OFDM symbol, and twelve data signals are arranged in the sixth OFDM symbol. Here, assuming a case where, by way of example, the power per reference signal is so defined as to be three times the power of the data signals (type A) in an OFDM symbol that does not have a reference signal, by defining the power of the data signals (type B) in an OFDM symbol that has reference signals to be ⅗ of the power of type A, it is possible to balance power among the OFDM symbols. To represent this point through an equation, assuming the power of R1=3, the power of D1 (type B)=⅗, and the power of D1 (type A)=1, the relationship

2×3+10×⅗=12×1

holds true.

Similarly, (b-1) schematically represents a reference signal and data signal power distribution for each transmit antenna with respect to the fifth OFDM symbol, which is an OFDM symbol in which there are reference signals for the case of two transmit antennas. In addition, (b-2) is a figure schematically representing a reference signal and data signal power distribution for each transmit antenna with respect to the sixth OFDM symbol, which is an OFDM symbol in which there is no reference signal. In the case of two transmit antennas, two reference signals per transmit antenna and eight data signals are arranged in the fifth OFDM symbol, and twelve data signals are arranged in the sixth OFDM symbol. Here, assuming a case where, by way of example, the power per reference signal is so defined as to be three times the power of the data signals (type A) in an OFDM symbol that does not have a reference signal, by defining the power of the data signals (type B) in an OFDM symbol that has reference signals to be ¾ of the power of type A, it is possible to balance power among the OFDM symbols. To represent this through an equation, assuming the power of R1=3, the power of D1 (type B)=¾, and the power of D1 (type A)=1, the relationship

2×3+8×¾=12×1

holds true for each transmit antenna.

Similarly, (c-1) is a figure schematically representing a reference signal and data signal power distribution for each transmit antenna with respect to the fifth OFDM symbol, which is an OFDM symbol in which there are reference signals for the case of four transmit antennas. In addition, (c-2) is a figure schematically representing a reference signal and data signal power distribution for each transmit antenna with respect to the sixth OFDM symbol, which is an OFDM symbol in which there is no reference signal. In the case of four transmit antennas, two reference signals per transmit antenna and eight data signals are arranged in the fifth OFDM symbol, and twelve data signals are arranged in the sixth OFDM symbol. Here, assuming a case where, by way of example, the power per reference signal is so defined as to be three times the power of the data signals (type A) in an OFDM symbol that does not have a reference signal, by defining the power of the data signals (type B) in an OFDM symbol that has reference signals to be ¾ of the power of type A, it is possible to balance power among the OFDM symbols. To represent this through an equation, assuming the power of R1=3, the power of D1 (type B)=⅘, and the power of D1 (type A)=1, the relationship

2×3+8×¾=12×1

holds true for each transmit antenna.

In Non-Patent Document 2 mentioned above, the values in FIG. 11 are defined as such data power ratios of type B to type A for the respective numbers of transmit antennas that a base station has, which are notified from a base station device to a terminal device through index P_B. These values are to be defined for each base station device in EUTRA, and the same values are used for all terminal devices communicating with the same base station device.

### (3) Uplink and Downlink Channel Configuration Example in LTE

FIG. 8 is a figure showing a channel configuration example in LTE. The downlink (communication from a base station device BS to a terminal device UE) in LTE comprises a downlink control region indicator channel (PCFICH: Physical Control Format Indicator Channel), a downlink hybrid resend request channel (PHICH: Physical Hybrid ARQ Indicator Channel), a downlink multicast channel (PMCH: Physical Multicast Channel), a downlink shared channel (PDSCH: Physical Downlink Shared Channel), a downlink control channel (PDCCH: Physical Downlink Control Channel), and a downlink broadcast channel (PBCH: Physical Boradcast Channel).

In addition to these channels, a synchronization signal (SCH: Synchronization Channel), which is a reference signal for synchronizing the terminal device UE and the base station device BS, as well as a reference signal (RS: Reference Signal), which is used as a reference when measuring signal quality and when demodulating a received signal, are also transmitted from the base station device BS to the terminal device UE.

On the other hand, the uplink (communication from the terminal device UE to the base station device BS) in LTE comprises a random access channel (RACH: Random Access Channel), an uplink shared channel (PUSCH: Physical Uplink Shared Channel), and an uplink control channel (PUCCH: Physical Uplink Control Channel).

In addition to these channels, a reference signal (RS: Reference Sygnal), which is used as a reference when measuring signal quality and when demodulating a received signal, is also transmitted from the terminal device UE to the base station device BS.

(4) Description regarding Coordinated Multipoint Transmission

In Coordinated Multipoint Transmission (CoMP), by transmitting signals from a plurality of base station devices, an effect of improving reception quality by virtue of the transmit diversity effect is attained, and an increase in transmission capacity by virtue of the spatial multiplexing effect is aimed for. In order to improve reception characteristics for terminal devices at cell edges, signals are simultaneously transmitted from a plurality of base station devices, and signals from a plurality of base station devices are received at terminal devices.

FIG. 9 is a figure generally showing a coordinated multipoint transmission scheme. A terminal device UE700 that is at the edge of a cell receives signals from a main base station device BS700, in addition to which it also simultaneously receives signals from base station devices BS701 and BS702 in its surroundings.

When the terminal device UE700 and the base station device BS700 are far apart, reception characteristics generally drop. By simultaneously receiving signals from the other base station devices BS701 and BS702 as well, degradation in characteristics is suppressed. A terminal device UE701 similarly communicates with its main base station device BS701, but because they are close in distance, coordinated reception is not performed. Depending on the location of the terminal device UE, the location(s) and number of base station devices to be used for multipoint coordinated transmission are adaptively varied. The base station devices are interconnected with communications lines referred to as backhauls.

By way of example, the data transmitted to the terminal device UE700 comprises data transmitted from the base station device 700 and data transmitted from BS701 via backhauls. Backhauls may be wired lines or wireless lines. In addition, in the case of wireless lines, there are in-band schemes that employ the same frequency band as the band used for signal communications and out-of-band schemes that employ a frequency band that differs from the band used for signal communications.

Coordination among the base station devices is controlled by a center device NC700 connected to backhauls, or is carried out by having each base station device be additionally equipped with the functionality of a center device, and having each base station device autonomously control itself while coordinating with respect to inter-base station device communications.

### PRIOR ART DOCUMENTS

### Non-Patent Documents

Non-Patent Document 1: 3GPP TS 36.211, V8.5.0 (2008-12), Technical Specification Group Radio Access Network; Evolved Universal Terrestrial Radio Access (E-UTRA); Physical Channels and Modulation (Release 8). http://wwww.3gpp.org/ftp/Specs/html-info/36211.htm
Non-Patent Document 2: 3GPP TS 36.331, V8.4.0 (2008-12), Technical Specification Group Radio Access Network; Evolved Universal Terrestrial Radio Access (E-UTRA); Radio Resource Control (RRC); Protocol specification (Release 8). http://www.3gpp.org/ftp/Specs/html-info/36331.htm
Non-Patent Document 3: 3GPP TS 36.213, V8.5.0 (2008-12), Technical Specification Group Radio Access Network; Evolved Universal Terrestrial Radio Access (E-UTRA); Physical layer procedures (Release 8). http://www.3gpp.org/ftp/Specs/html-info/36213.htm
Non-Patent Document 4: 3GPP TS 36.814, V1.0.0 (2009-02), 3rd Generation Partnership Project; Technical Specification Group Radio Access Network; Further Advancements for E-UTRA Physical Layer Aspects (Release 9)

### SUMMARY OF THE INVENTION

### Problems to be Solved by the Invention

In coordinated multipoint transmission, the received power at a terminal device would be a combination of received signals transmitted from base station devices performing coordinated multipoint transmission. FIG. 12 is a schematic diagram representing the powers of reference signals R, type A data signals Da, and type B data signals Db with respect to a case in which coordinated multipoint transmission is performed using two base station devices (base station device 1 and base station device 2). The vertical direction represents power. Here, the numerals appended to R, Da, and Db are the numbers of the base station devices. Specifically, it is assumed that the numeral 1 represents signals from the base station device 1, and the numeral 2 represents signals from the base station device 2. (a-1) and (a-2) respectively represent the powers of the transmission signals from the base station device 1 and the base station device 2. (b-1) and (b-2) respectively represent the powers of the transmission signals from the base station device 1 and the base station device 2 as attenuated by propagation channels. Depending on the distance and condition of propagation from each base station device to the terminal device, the amount of attenuation varies from base station device to base station device. (c) represents combined signals from each of the base station devices received at the terminal device.

Here, it is assumed that the powers of the reference signals at the two base station devices are respectively as follows.

Base station device 1: P(R1)

Base station device 2: P(R2)

In addition, assuming that ratio ρA of type A data signal to reference signal is the same value for both, the following definitions are made.

Base station device 1: P(Da1)=P(R1)*ρA

Base station device 2: P(Da2)=P(R2)*ρA

Here, assuming that ratio ρB of type B data signal to type A data signal is the same value for both, the transmission signal powers for type B are defined as follows.

Base station device 1: P(Db1)=P(Da1)*ρB

Base station device 2: P(Db2)=P(Da2)*ρB

Next, assuming the attenuation from the base station device 1 to the terminal device and the attenuation from the base station device 2 to the terminal device are k1 and k2, respectively, the signal powers from the respective base station devices, as attenuated, are as follows based on the equations above.

Base station device 1:

Reference signal power P′(R1)=P(R1)×k1

Type A data power P′(Da1)=P(R1)×ρA×k1

Type B data power P′(Db1)=P(R1)×ρA×ρB×k1

Base station device 2:

Reference signal power P′(R2)=P(R2)×k2

Type A data power P′(Da2)=P(R2)×ρA×k2

Type B data power P′(Db2)=P(R2)×ρA×ρB×k2

The signals received by the terminal device are combined signals of the above, which are as follows.

$$Reference signal power P ” ( R ) = P ( R 1 ) \times k 1 + P ( R 2 ) \times k 2$$

$$\begin{matrix}Type A data power P ” ( Da ) = ( P ( R 1 ) \times k 1 + P ( R 2 ) \times k 2 ) \times ρ A \\ = P ” ( R ) \times ρ A\end{matrix}$$

$$\begin{matrix}Type B data power P ” ( Db ) = ( P ( R 1 ) \times k 1 + P ( R 2 ) \times k 2 ) \times ρ A \times ρ B \\ = p ” ( R ) ρ A \times ρ B\end{matrix}$$

The values of ρA and ρB are notified from the base station devices to the terminal device in advance. Thus, the terminal device is able to calculate the data power for type A and the data power for type B based on the powers of the received reference signals.

However, as previously discussed, the value of ρB is a value that is defined per base station device. The value of ρB is semi-fixedly defined taking the number of antennas of the base station device, cell radius, reference signal power, etc., into account. In performing multipoint coordinated transmission, the value of ρB may not necessarily be equal among the base station devices performing multipoint transmission. Considering now a case in which the value of ρB varies among the base station devices, assuming those values are ρB1 and ρB2 for the respective base station devices, the signals received by the terminal device would respectively be as follows.

$$Reference signal power P ” ( R ) = P ( R 1 ) \times k 1 + P ( R 2 ) \times k 2 \\ \begin{matrix} Type A data power P ” ( Da ) = ( P ( R 1 ) \times k 1 + P ( R 2 ) \times k 2 ) \times ρ A \\ = P ” ( R ) \times ρ A\end{matrix} \\ Type B data power P ” ( Db ) = ( P ( R 1 ) \times k 1 \times ρ B 1 + P ( R 2 ) \times k 2 \times ρ B 2 ) \times ρ A$$

Accordingly, the data power for type B cannot be calculated based on the received reference signals and the values of ρA, ρB1, and ρB2 that are notified. This would mean that, in the context of multilevel modulation schemes that require data power information for demodulation, such as QAM modulation, type B data cannot be demodulated, which is a problem.

The present invention is made in view of such circumstances, and an object thereof is to provide a technique with which, in performing multipoint transmission, the powers of data signals of received signals may be derived properly.

### Means for Solving the Problems

According to one aspect of the present invention, there is provided a base station device that communicates with a terminal device on its own or in coordination with another base station device, the base station device comprising: means that indicates the availability of the coordinated communication; and means that determines, in accordance with the availability of the coordinated communication, a ratio of the power of a data signal with respect to a transmission symbol including a reference signal to the power of a data signal with respect to a transmission symbol not including a reference signal. It is preferable that it comprise means that transmits, to the terminal device, information indicating the ratio of the power of the data signal with respect to the transmission symbol including the reference signal to the power of the data signal with respect to the transmission symbol not including the reference signal.

In addition, the present invention is a terminal device that communicates with a base station device that is coordinated with another base station device, the terminal device comprising means that receives, from the base station device, information indicating the ratio of the power of a data signal with respect to a transmission symbol including a reference signal to the power of a data signal with respect to a transmission symbol not including the reference signal.

In addition, there is provided a radio communication system in which coordinated multipoint transmission is performed among a plurality of base station devices and a terminal device, wherein, in a multi-carrier communication system in which communication is performed employing a transmission symbol including a reference signal and a transmission symbol not including a reference signal, a transmitter device of the base station devices comprises at least: means that communicates with an inter-base station device network of the radio communication system; means that indicates the availability of the coordinated multipoint transmission; means that determines the ratio of the power of a data signal with respect to the transmission symbol including the reference signal to the power of a data signal with respect to the transmission symbol not including the reference signal; and means that transmits each of information of the power of the data signal with respect to the transmission symbol including the reference signal and the power of the data signal with respect to the transmission symbol not including the reference signal, and wherein the means that determines the ratio of the power of the data signal with respect to the transmission symbol including the reference signal to the power of the data signal with respect to the transmission symbol not including the reference signal performs each of power ratio definition for a case in which the coordinated multipoint transmission is not performed and power ratio definition for a case in which the coordinated multipoint transmission is performed, and determines the power ratio depending on the availability of the coordinated multipoint transmission.

When performing coordinated multipoint transmission, it is preferable that the radio communication system define the ratio of the power of the data signal with respect to the transmission symbol including the reference signal to the power of the data signal with respect to the transmission symbol not including the reference signal so as to be the same value among the base station devices performing the coordinated multipoint transmission. When performing coordinated multipoint transmission, it is preferable that the base station devices define the ratio of the power of the data signal with respect to the transmission symbol including the reference signal to the power of the data signal with respect to the transmission symbol not including the reference signal to be the same value among the base stations performing the coordinated multipoint transmission, and that they notify the terminal device of the ratio of the power of the data signal with respect to the transmission symbol not including the reference signal to the power of the reference signal. In addition, it is preferable that the base station devices notify the terminal device of each of, in an individual manner, power ratio definition for a case in which the coordinated multipoint transmission is not performed and power ratio definition for a case in which the coordinated multipoint transmission is performed.

In addition, the present invention is a base station device in a multi-carrier communication system in which communication is performed employing a transmission symbol including a reference signal and a transmission symbol not including a reference signal, and which is a radio communication system in which coordinated multipoint transmission is performed among a plurality of base station devices and a terminal device, wherein a transmitter device of the base station device comprises at least: means that communicates with an inter-base station device network of the radio communication system; means that indicates the availability of the coordinated multipoint transmission; means that determines the ratio of the power of a data signal with respect to the transmission symbol including the reference signal to the power of a data signal with respect to the transmission symbol not including the reference signal; and means that transmits each of information of the power of the data signal with respect to the transmission symbol including the reference signal and the power of the data signal with respect to the transmission symbol not including the reference signal, and wherein the means that determines the ratio of the power of the data signal with respect to the transmission symbol including the reference signal to the power of the data signal with respect to the transmission symbol not including the reference signal performs each of power ratio definition for a case in which the coordinated multipoint transmission is not performed and power ratio definition for a case in which the coordinated multipoint transmission is performed, and determines the power ratio depending on the availability of the coordinated multipoint transmission. When performing coordinated multipoint transmission, it is preferable that the ratio of the power of the data signal with respect to the transmission symbol including the reference signal to the power of the data signal with respect to the transmission symbol not including the reference signal be defined so as to be the same value among the base station devices performing the coordinated multipoint transmission. When performing the coordinated multipoint transmission, it is preferable that the ratio of the power of the data signal with respect to the transmission symbol including the reference signal to the power of the data signal with respect to the transmission symbol not including the reference signal be defined so as to be the same value among the base stations performing the coordinated multipoint transmission, and that the terminal device be notified of the ratio of the power of the data signal with respect to the transmission symbol not including the reference signal to the power of the reference signal. It is preferable that the terminal device be separately notified of each of, in an individual manner, power ratio definition for a case in which the coordinated multipoint transmission is not performed and power ratio definition for a case in which the coordinated multipoint transmission is performed.

In addition, the present invention is a radio communication system in which coordinated multipoint transmission is performed among at least a plurality of base station devices and a terminal device, wherein, in a multi-carrier communication system in which communication is performed employing a transmission symbol including a reference signal and a transmission symbol not including a reference signal, a transmitter device of the base station devices comprises at least: means that communicates with an inter-base station network of the radio communication system; means that indicates the availability of the coordinated multipoint transmission; means that determines the ratio of the power of a data signal with respect to the transmission symbol including the reference signal to the power of a data signal with respect to the transmission symbol not including the reference signal; and means that transmits each of information of the power of the data signal with respect to the transmission symbol including the reference signal and the power of the data signal with respect to the transmission symbol not including the reference signal, and wherein a receiver device of the terminal device is a terminal device that comprises at least: means that receives a reference signal of each base station device performing the coordinated multipoint transmission; means that performs propagation channel estimation of from each base station device to the terminal device; means that receives information of, with respect to each base station device, the ratio of the power of the data signal with respect to the transmission symbol including the reference signal to the power of the data signal with respect to the transmission symbol not including the reference signal; and means that calculates a received data power of when coordinated multipoint transmission is performed.

In addition, it is a terminal device employed in a multi-carrier communication system in which, with respect to a multi-carrier communication system in which communication is performed employing a transmission symbol including a reference signal and a transmission symbol not including a reference signal, and which is a radio communication system in which coordinated multipoint transmission is performed among at least a plurality of base station devices and the terminal device, a transmitter device of the base station devices comprises at least: means that communicates with an inter-base station network of the radio communication system; means that indicates the availability of the coordinated multipoint transmission; means that determines the ratio of the power of a data signal with respect to the transmission symbol including the reference signal to the power of a data signal with respect to the transmission symbol not including the reference signal; and means that transmits each of information of the power of the data signal with respect to the transmission symbol including the reference signal and the power of the data signal with respect to the transmission symbol not including the reference signal, wherein a receiver device of the terminal device is a terminal device comprising at least: means that receives a reference signal of each base station device performing the coordinated multipoint transmission; means that performs propagation channel estimation of from each base station device to the terminal device; means that receives information of, with respect to each base station device, the ratio of the power of the data signal with respect to the transmission symbol including the reference signal to the power of the data signal with respect to the transmission symbol not including the reference signal; means that receives power ratio information of, with respect to each of the base station devices, the power of the reference signal to the power of the data signal with respect to the transmission symbol not including the reference signal; and means that calculates a received data power of when coordinated multipoint transmission is performed.

In addition, the present invention is a transmission method for a base station device which is a multi-carrier communication method in which communication is performed employing a transmission symbol including a reference signal and a transmission symbol not including a reference signal in a radio communication system in which coordinated multipoint transmission is performed among a plurality of base station devices and a terminal device, comprising: a step of transmitting, to the terminal device, information of the ratio during single point transmission of the power of the reference signal with respect to the transmission symbol including the reference signal to the power of a data signal with respect to the transmission symbol not including the reference signal, and information of the ratio during single point transmission of the power of a data signal with respect to the transmission symbol including the reference signal to the power of the data signal with respect to the transmission symbol not including the reference signal from the base station device to the terminal device; a step of, when performing the coordinated multipoint transmission, defining the ratio during the coordinated multipoint transmission of the power of the reference signal with respect to the transmission symbol including the reference signal to the power of the data signal with respect to the transmission symbol not including the reference signal as well as the ratio during the coordinated multipoint transmission of the power of the data signal with respect to the transmission symbol including the reference signal to the power of the data signal with respect to the transmission symbol not including the reference signal to be the same values among the base station devices; a step of transmitting, of during the coordinated multipoint transmission, information of the ratio of the power of the reference signal with respect to the transmission symbol including the reference signal to the power of the data signal with respect to the transmission symbol not including the reference signal and information of the ratio of the power of the data signal with respect to the transmission symbol including the reference signal to the power of the data signal with respect to the transmission symbol not including the reference signal to the terminal device; and a step of switching, in accordance with the availability of the coordinated multipoint transmission, the ratio of the power of the reference signal with respect to the transmission symbol including the reference signal to the power of the data signal with respect to the transmission symbol not including the reference signal, as well as the ratio of the power of the data signal with respect to the transmission symbol including the reference signal to the power of the data signal with respect to the transmission symbol not including the reference signal.

In addition, the present invention is a transmission method for a base station device which is a multi-carrier communication method in which communication is performed employing a transmission symbol including a reference signal and a transmission symbol not including a reference signal in a radio communication system in which coordinated multipoint transmission is performed among a plurality of base station devices and a terminal device, comprising: a step of transmitting, to the terminal device, information of the ratio during single point transmission of the power of the reference signal with respect to the transmission symbol including the reference signal to the power of a data signal with respect to the transmission symbol not including the reference signal, and information of the ratio during single point transmission of the power of a data signal with respect to the transmission symbol including the reference signal to the power of the data signal with respect to the transmission symbol not including the reference signal from the base station device to the terminal device; a step of, when performing the coordinated multipoint transmission, defining the ratio during the coordinated multipoint transmission of the power of the reference signal with respect to the transmission symbol including the reference signal to the power of the data signal with respect to the transmission symbol not including the reference signal as well as the ratio during the coordinated multipoint transmission of the power of the data signal with respect to the transmission symbol including the reference signal to the power of the data signal with respect to the transmission symbol not including the reference signal to be the same values among the base station devices; a step of transmitting, to the terminal device, information of the ratio during the coordinated multipoint transmission of the power of the reference signal with respect to the transmission symbol including the reference signal to the power of the data signal with respect to the transmission symbol not including the reference signal as a value for coordinated multipoint transmission; and a step of switching, in accordance with the availability of coordinated point transmission, the ratio of the power of the reference signal with respect to the transmission symbol including the reference signal to the power of the data signal with respect to the transmission symbol not including the reference signal, as well as the ratio of the power of the data signal with respect to the transmission symbol including the reference signal to the power of the data signal with respect to the transmission symbol not including the reference signal.

Further, the present invention is a reception method for a terminal device which is a multi-carrier communication method in which communication is performed employing a transmission symbol including a reference signal and a transmission symbol not including a reference signal in a radio communication system in which coordinated multipoint transmission is performed among a plurality of base station devices and the terminal device, comprising: a step in which the terminal device receives a base station specific reference signal per base station device performing the coordinated multipoint transmission; a step of calculating a channel attenuation amount between each base station device and the terminal device based on the received base station specific reference signal per base station device; a step of receiving, per base station device, information of the ratio of the power of a reference signal with respect to the transmission symbol including the reference signal to the power of a data signal with respect to the transmission symbol not including the reference signal, as well as information of the ratio of the power of a data signal with respect to the transmission symbol including the reference signal to the power of the data signal with respect to the transmission symbol not including the reference signal; and a step of calculating the power of a reception data signal based on the base station specific reference signal per base station device, the calculated channel attenuation amounts between the base station devices and the terminal device, the received information of the ratio of the power of the reference signal with respect to the transmission symbol including the reference signal to the power of the data signal with respect to the transmission symbol not including the reference signal, and the information of the ratio of the power of the data signal with respect to the transmission symbol including the reference signal to the power of the data signal with respect to the transmission symbol not including the reference signal. If the values of ρA and ρB are the same as the values for single point transmission, it is also possible to omit this notification. In addition, this notification may also be transmitted collectively from one base station device instead of being performed individually from each base station device.

The present invention may also be a program for causing a computer to execute the above-mentioned transmission/reception methods, and it may also be a computer-readable recording medium on which such a program is recorded. The program may also be obtained via a transmission medium such as the Internet, etc.

The contents disclosed in the specification and/or drawings of JP Patent Application No. 2009-105371, from which the present application claims priority, are incorporated into the present specification.

### Effects of the Invention

According to the present invention, it is possible to correctly derive the power of a data signal at a terminal device in a multi-carrier communication system in which communication is performed employing a transmission symbol including a reference signal and a transmission symbol not including a reference signal, and which is a communication system in which multipoint transmission is performed.

### BRIEF DESCRIPTION OF THE DRAWINGS

FIG. 1 is a diagram showing one example of a base station device with respect to an embodiment of a multi-carrier communication system of the present invention.

FIG. 2 is a diagram showing one example of a terminal device with respect to the first embodiment of a multi-carrier communication system of the present invention.

FIG. 3 is a flowchart showing one example of a power defining method with respect to the first embodiment of a multi-carrier communication system of the present invention.

FIG. 4 is a flowchart showing one example of a power defining method with respect to the second embodiment of a multi-carrier communication system of the present invention.

FIG. 5 is a flowchart showing one example of a power defining method with respect to the third embodiment of a multi-carrier communication system of the present invention.

FIG. 6 is a downlink radio frame structure example for EUTRA proposed in 3GPP.

FIG. 7 is a diagram showing values of ρA specified in EUTRA proposed in 3GPP.

FIG. 8 is a diagram showing a channel configuration example in LIE.

FIG. 9 is a diagram showing an outline of a coordinated multipoint transmission scheme.

FIG. 10 is a diagram showing the concept of reference signal and data power with respect to each OFDM symbol in EUTRA.

FIG. 11 shows data power ratios of type B to type A with respect to each number of transmit antennas of a base station as specified in 3GPP.

FIG. 12 shows schematic diagrams representing the powers of reference signals, type A data signals and type B data signals with respect to two base station devices in a case where coordinated multipoint transmission is performed.

### LIST OF REFERENCE NUMERALS

1 . . . transmitter device, 3 . . . data signal processing part, 4 . . . turbo encoder part, 5 . . . data modulation part, 6 . . . preceding part, 7 . . . weighting part, 8 . . . control signal processing part, 9 . . . convolutional encoder part, 10 . . . QPSK modulation part, 11 . . . precoding part, 12 . . . weighting part, 13 . . . reference signal generator part, 14 . . . power determining part, 15 . . . control part, 16 . . . coordinated multipoint transmission configuration part, 17 . . . backhaul interface, 18 . . . multiplexing part, 19 . . . IFFT part, 20 . . . CP insertion part, 21 . . . D/A part, 22 . . . transmit RF part, 23 . . . transmit antenna, 24 . . . OFDM transmission part, 32 . . . receive antenna, 33 . . . receive RF part, 34 . . . A/D part, 35 . . . CP removal part, 36 . . . FFT part, 37 . . . demultiplexing part, 38 . . . propagation channel estimation part, 39 . . . propagation channel compensation part, 40 . . . multiplexing mode restoration part, 41 . . . data demodulation part, 42 . . . turbo decoder part, 43 . . . propagation channel compensation part, 44 . . . multiplexing mode restoration part, 45 . . . QPSK demodulation part, 46 . . . convolutional decoder part, 47 . . . control part, 48 . . . signal power determining part, 49 . . . receiver device.

### MODES FOR CARRYING OUT THE INVENTION

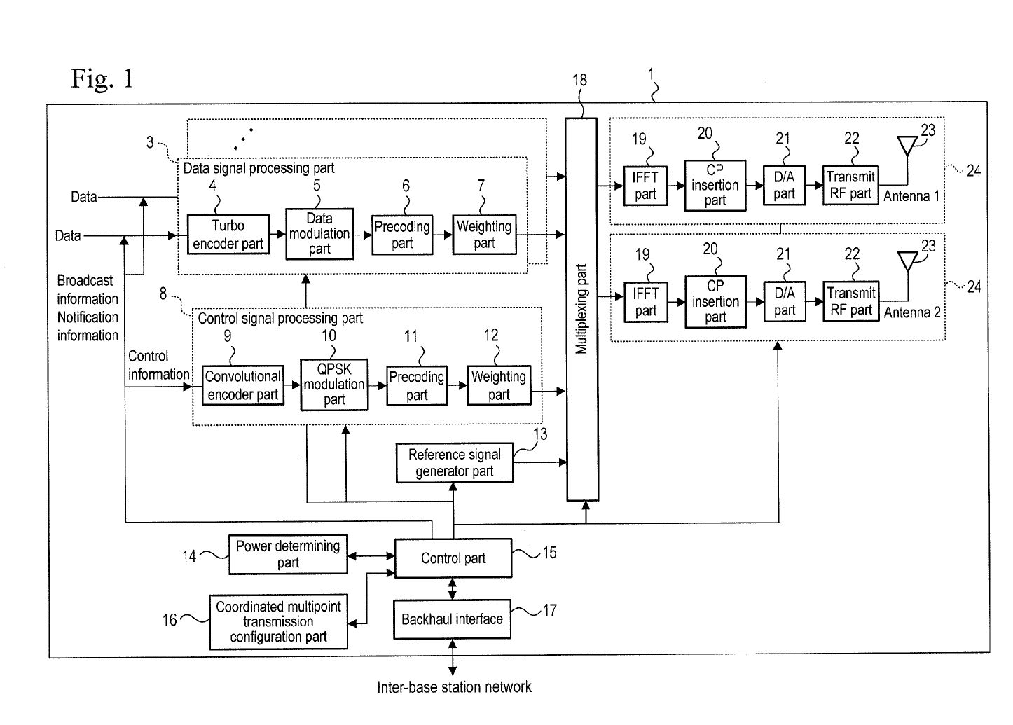

A multi-carrier communication technique according to embodiments of the present invention is described below with reference to the drawings. FIG. 1 is a functional block diagram showing one configuration example of a transmitter device within a base station device in a case where a multi-carrier communication system according to the first embodiment of the present invention is applied to two transmit antennas.

Data to be transmitted is inputted to a transmitter device 1. In addition, in conjunction with the data to be transmitted in the form of data signals, a portion of information regarding the power control to be applied, and of such information as the number of transmit antennas, coordinated multipoint transmission mode, etc. (broadcast information, notification information), is also inputted. Such data are inputted to a turbo encoder part 4 within a data signal processing part 3.

In accordance with instructions from a control part (CPU) 15 on code rates, the turbo encoder part 4 performs error correction coding based on turbo codes for enhancing the error resilience of the inputted data. A data modulation part 5 of the next stage modulates the data, which has undergone error correction coding by the turbo encoder part 4, by a modulation scheme instructed by the control part 15 from among several modulation schemes such as QPSK (Quadrature Phase Shift Keying), 16-QAM (16 Quadrature Amplitude Modulation), 64-QAM (64 Quadrature Amplitude Modulation), etc. By performing, in accordance with a multiplexing mode instructed by the control part 15, phase rotation, weighting, redundancy, etc., on the signal modulated by the data modulation part 5, a precoding part 6 generates a signal for each transmit antenna to be transmitted to each mobile station device.

A weighting part 7 performs weighting on the signal from the precoding part 6 based on the power defined at a power determining part 14, and outputs it to a multiplexing part 18. While the weighting part 7 may be included as part of a weighting function of the precoding part 6, it is described as a separate feature with respect to FIG. 1.

In order to process a plurality of data streams, a plurality of the data signal processing parts 3 are provided as shown in the diagram. The processing performed by each is the same. Control information is inputted to a convolutional encoder part 9 of a control signal processing part 8. In accordance with instructions on code rates from the control part 15, the convolutional encoder part 9 performs error correction coding based on convolutional codes for enhancing the error resilience of the inputted information.

A QPSK modulation part 10 modulates, by a QPSK modulation scheme, the control information that has undergone error correction coding by the convolutional encoder part 9. By performing, in accordance with a multiplexing mode instructed by the control part 15, phase rotation, weighting, redundancy, etc., on the signal modulated by the QPSK modulation part 10, a precoding part 11 generates a control signal for each transmit antenna to be transmitted to each mobile station device. A weighting part 12 performs weighting on the signal from the precoding part 11 based on the power defined at the power determining part 14, and outputs it to the multiplexing part 18. The fact that this weighting part 7 may be included as part of a weighting function of the precoding part 6 similarly applies as in the case of the data signal processing part 3.

A reference signal generator part 13 generates a reference signal to be transmitted by each transmit antenna 23 of the transmitter device 1.

The power determining part 14 defines the powers of reference signals, data signals, control signals, etc., and defines the values of ρA and ρB. With respect to a terminal device for which performing coordinated multipoint transmission has been specified via a backhaul interface 17, a coordinated multipoint transmission configuration part 16 configures settings relating to coordinated multipoint transmission. The backhaul interface 17 serves as an interface in performing communication with other base station devices and center devices via an inter-base station device network with respect to the exchange of settings and data regarding coordinated multipoint transmission and other information regarding the network.

At the multiplexing part 18, the respective transmission data, control information and reference signals outputted from the respective data signal processing parts 3, the control signal processing part 8 and the reference signal generator part 13 are sent to OFDM transmission parts 24 of the respective antennas by determining placement with respect to resource elements in accordance with the scheme of the transmission mode instructed by the control part 15, and generating a signal per antenna.

Each OFDM transmission part 24 (in the diagram, two OFDM transmission parts 24 are provided in correspondence with the two antennas 23) comprises, in order from the input side, an IFFT (inverse Fourier transform) part 19, a CP insertion part 20, a D/A part 21, a transmit RF part 22, and a transmit antenna 23. The function of each of the plurality of OFDM transmission parts 24 is the same.

The IFFT part 19 performs inverse fast Fourier transform on the signal inputted from the multiplexing part 18 to perform modulation of an OFDM scheme. The CP insertion part 20 adds a cyclic prefix (CP) to a signal that has already undergone OFDM modulation, thereby generating symbols of an OFDM scheme. Cyclic prefixes may be obtained through known methods where a portion at the beginning or end of symbols to be transmitted is duplicated. The D/A part 21 D/A converts a baseband digital signal inputted from the CP insertion part 20 into an analog signal. The transmit RF part 22 generates, from the analog signal inputted from the D/A part 21, an in-phase component and a quadrature component of an intermediate frequency, removes unwanted frequency components with respect to the intermediate frequency band, converts the signal of the intermediate frequency to a signal of a high frequency (up-convert), removes unwanted frequency components, amplifies the power, and outputs it to the transmit antenna 23.

It is noted that in the present embodiment, there has been provided an example comprising two OFDM transmission parts. However, in the case of one antenna or four antennas, one or four OFDM transmission part(s), respectively, is/are provided.

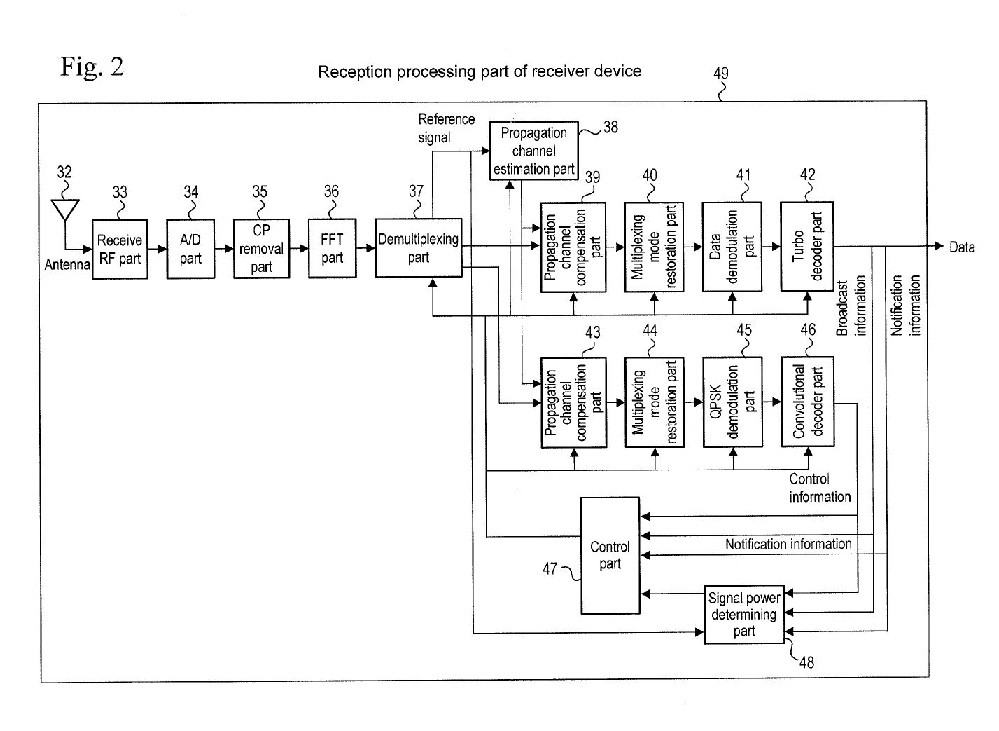

FIG. 2 is a functional block diagram showing one configuration example of a receiver device of a terminal device of a multi-carrier communication device according to one embodiment of the present invention. As shown in FIG. 2, a reception processing part 49 of a receiver device according to the present embodiment comprises an antenna 32, a receive RF part 33, an A/D part 34, a CP removal part 35, an FFT part 36, a demultiplexing part 37, a propagation channel estimation part 38, a propagation channel compensation part 39, a multiplexing mode restoration part 40, a data demodulation part 41, a turbo decoder part 42, a propagation channel compensation part 43, a multiplexing mode restoration part 44, a QPSK demodulation part 45, a convolutional decoder part 46, a control part 47, and a signal power determining part 48.

The receive RF part 33 amplifies the signal received via the receive antenna 32, converts it to the intermediate frequency (down-convert), removes unwanted frequency components, controls the amplification level so that the signal level would be maintained appropriately, and performs quadrature demodulation based on the in-phase component and the quadrature component of the received signal. The A/D part 34 converts the analog signal that has undergone quadrature demodulation by the receive RF part 33 into a digital signal. The CP removal part 35 removes from the digital signal outputted by the A/D part 34 the part corresponding to a cyclic prefix. The FFT part 36 performs fast Fourier transform on the signal inputted from the CP removal part 35 to perform demodulation of an OFDM scheme. The propagation channel compensation part 39 up to the turbo decoder part 42 are used for a demodulation process for a data signal, and the propagation channel compensation part 43 up to the convolutional decoder part 46 for a demodulation process for a control information signal.

Based on instructions from the control part 47, the demultiplexing part 37 extracts and outputs, from a signal which has undergone Fourier transform by the FFT part 36, that is, a reception signal that has been demodulated by an OFDM scheme, a reference signal from the resource element in which it is located. Specifically, the demultiplexing part 37 extracts a reference signal which has a fixed location, and outputs it to the propagation channel estimation part 38. In addition, the demultiplexing part 37 performs separation of the data signal and the control information signal.

Based on a reception result of the known reference signal separated and extracted by the demultiplexing part 37, the propagation channel estimation part 38 estimates propagation channel variation with respect to each of a transmit antenna 1 and a transmit antenna 2 of a transmitter device 1, and outputs a propagation channel variation compensation value. Based on the propagation channel variation compensation value from the propagation channel estimation part 38, the propagation channel compensation parts 39 and 43 perform compensation on the inputted signal for propagation channel variation. With respect to the signals that have been compensated for propagation channel variation respectively by the propagation channel compensation parts 39 and 43, the multiplexing mode restoration parts 40 and 44 reproduce and synthesize, based on the transmission mode used by the transmitter device and taking into account the data power determined by the signal power determining part 48, frequency sets of each antenna for the transmission signals generated by the transmitter device, and generates signals as of before redundancy was added.

The data demodulation part 41 demodulates the data signals generated by the multiplexing mode restoration part 40. The demodulation carried out here is such that it corresponds to the modulation scheme employed at the data modulation parts 5 of the transmitter device 1, and information regarding the modulation scheme is instructed from the control part 47. The turbo decoder part 42 decodes the data signals demodulated by the data demodulation part 41. Of the decoded data, notification information and broadcast information are extracted and inputted to the control part 47. In addition, information regarding power is inputted to the signal power determining part 48. The QPSK demodulation part 45 performs QPSK demodulation of the control information signal generated by the multiplexing mode restoration part 44. The convolutional decoder part 46 decodes the control information signal demodulated by the multiplexing mode restoration part 44. At the signal power determining part 48, the power of the reception signal is determined based on the power of the reference signal separated at the demultiplexing part 37, and on information contained in the control information, broadcast information and notification information.

### First Embodiment

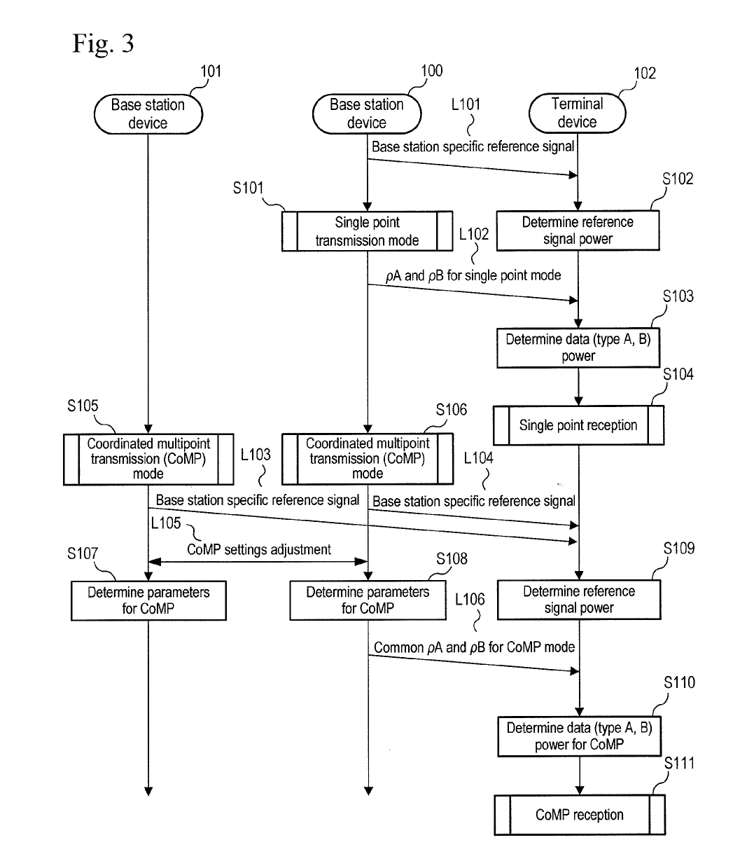

FIG. 3 is a flowchart showing one example of a power defining method according to the first embodiment of the present invention. When a terminal device 102 performs single point transmission with a base station device 100, the base station device 100 transmits a base station specific reference signal (L101). It is noted that that base station specific reference signal is constantly transmitted regardless of the timing indicated in the chart, regardless of whether or not the single point transmission is coordinated multipoint transmission, and regardless of whether or not there exists a terminal device. The terminal device 102 determines the received power of the reference signal directly from the received reference signal (S102). Next, the base station device 100 transmits ρA and ρB, which are power defining parameters for single point transmission, to the terminal device (L102). Based on the power of the earlier reference signal and the received ρA and ρB, the terminal device is able to determine the powers of type A and type B data (S103), and to demodulate and receive data (S104).

Next, if the terminal device is to perform coordinated multipoint transmission (CoMP), the terminal device would also be receiving signals from a base station device 101 that is used for CoMP. As discussed earlier, the base station device is constantly transmitting the base station specific reference signal (L103). The terminal device also receives the base station specific reference signal from this base station device (herein referred to as a coordinated base station) 101. On the other hand, it also receives the base station specific reference signal from the previous base station device (herein referred to as the main base station) (L104), and determines the power of each reference signal (S109).

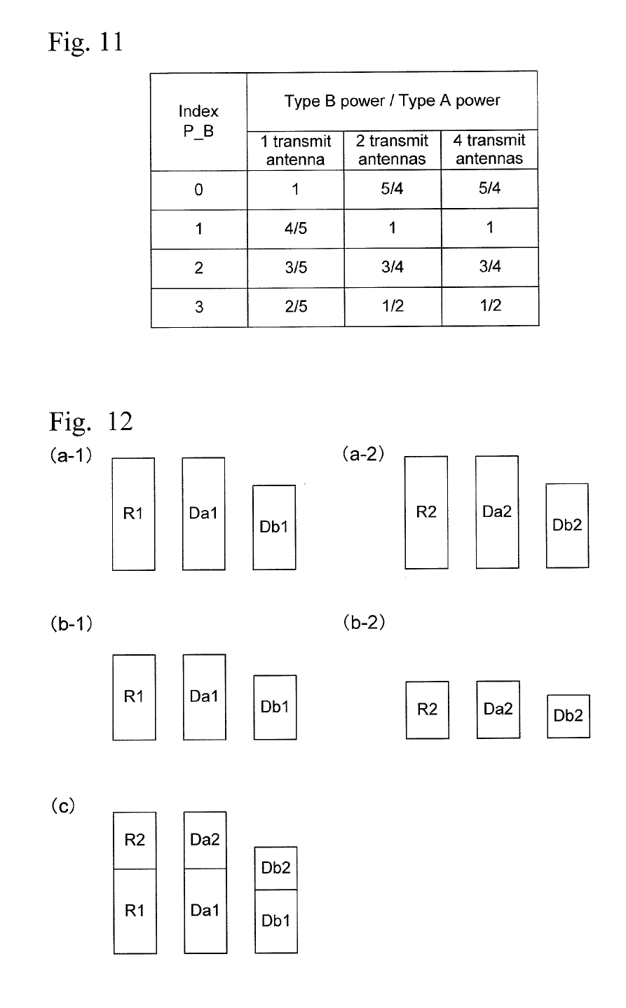

The base station devices 100 and 101 that perform CoMP adjust the parameters to be used and scheduling among the base station devices (L105), and each determines parameters for CoMP (S108, S107). In so doing, ρA and ρB, which are power parameters, are defined to be the same. Although ρB is fundamentally, as discussed earlier, a setting that is specific to the base station and cannot be changed, in the present invention, in the event of CoMP, the same value is defined for both base station devices as a parameter for CoMP, and notified to the terminal device (L106). There is no problem if this ρB value were consequently to become a value that is different from the ρB value during single point transmission that is specific to the base station device. In addition, if, as shown in FIG. 11, the number of antennas of the base stations that perform coordinated multipoint transmission is such that one base station device has one transmit antenna, and the other base station device has two or four transmit antennas, P_B, which is an index representing ρB, would be a different interpretation of ρB depending on the number of antennas. However, by way of example, this may also be made to be an interpretation that is always dictated by the number of antennas of the main base station device, or if coordinated multipoint transmission is to be performed, it may be interpreted by always assuming a case of one transmit antenna or two/four transmit antennas. In the latter case, the base station device may explicitly communicate to the terminal device whether or not coordinated multipoint transmission is performed, and it may also explicitly communicate which interpretation, namely one transmit antenna or two/four transmit antennas, is to be adopted. Alternatively, a new value may be defined when performing coordinated multipoint transmission. By performing this notification of power parameters for each terminal, parameter ρB for conventional single point transmission mode may be sent to a terminal device that belongs to the same base station device and does not perform CoMP, while sending parameter ρB for CoMP to the base station devices that perform CoMP. Based on the received ρA and ρB as well as the power of the earlier reference signal, the terminal device is able to calculate the type A and type B powers (S110) and perform CoMP reception (S111). It is noted that with respect to the present embodiment, there has been provided a description for an example in which this notification is notified only from the main base station device 100, however, it may be sent from the coordinated base station device 101, and it may also be sent from both.

Thus, in embodiments of the present invention, with respect to ρB, which is a setting specific to each base station device, by separately defining, in the event of CoMP, a ρB value as a common setting among the base station devices performing CoMP, it is possible to properly determine data power at the terminal device even during CoMP. In addition, by separately sending notifications of ρB's for single point reception and for CoMP, even in cases where, by way of example, the switch as to whether or not CoMP is to be performed is performed dynamically per sub-frame using the downlink control channel, etc., since the terminal device is aware of both ρB's, there is an advantage in that data power can be determined properly in accordance with the switch.

### Second Embodiment

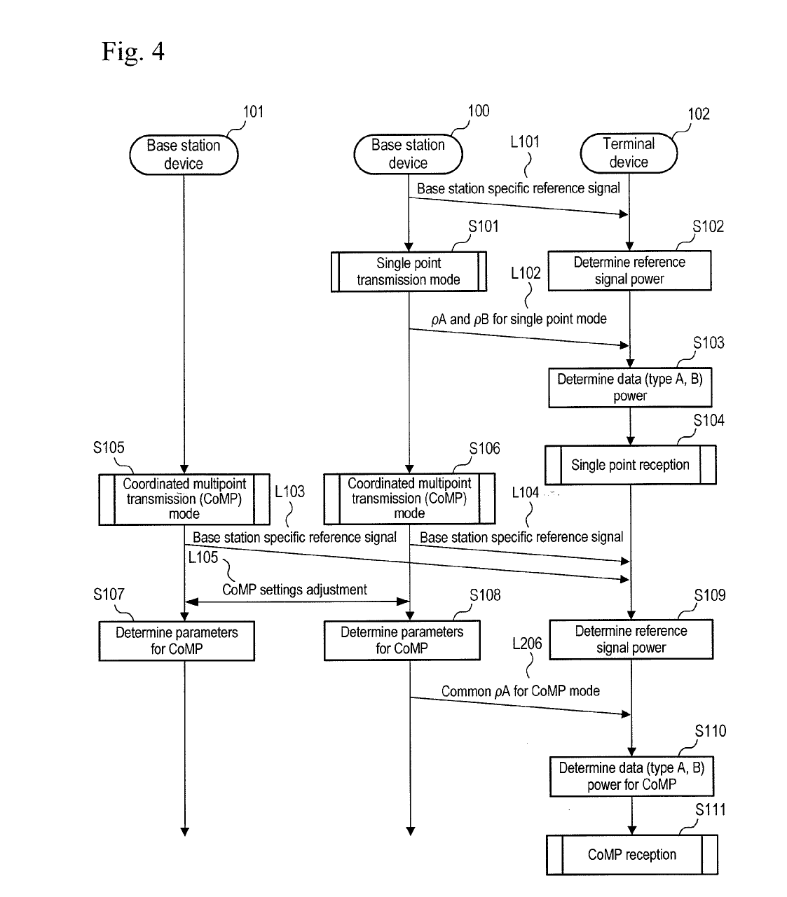

FIG. 4 is a flowchart representing one example of a power defining step with respect to a case where a notification of ρB for CoMP is not explicitly performed, which is the second embodiment of the present invention. In the first embodiment, ρB for CoMP was notified separately from ρB for single point reception, in which case, however, it was necessary to perform a new notification.

In the present embodiment, even if the base station changes the ratio of type B data power to type A data power during CoMP, notification as ρB is not performed. Notification is performed by changing ρA, which is the power ratio of type A to reference signal. Since ρA is supposed to be notified specifically per terminal device to begin with, there is an advantage in that performing notifications by changing ρA does not change the amount of notifications.

With respect to FIG. 4, the same description as that of the first embodiment applies to the procedure up to entering CoMP mode and will be omitted. The same description applies to the receiving of a reference signal from each base station device as well and will be omitted. The base station devices 100 and 101 that perform CoMP similarly adjust the parameters to be used and scheduling among the base station devices (L105), and each determines parameters for CoMP (S108, S107). In so doing, ρA and ρB, which are power parameters, are defined to be the same as is done in the first embodiment, but a new parameter notification is not performed with respect to ρB. Instead, notification is performed by defining ρA as being for CoMP (L206). Thus, since a new notification of ρB is not performed in the present embodiment, there is an advantage in that the amount of signaling does not change as compared to the case of single point transmission.

### Third Embodiment

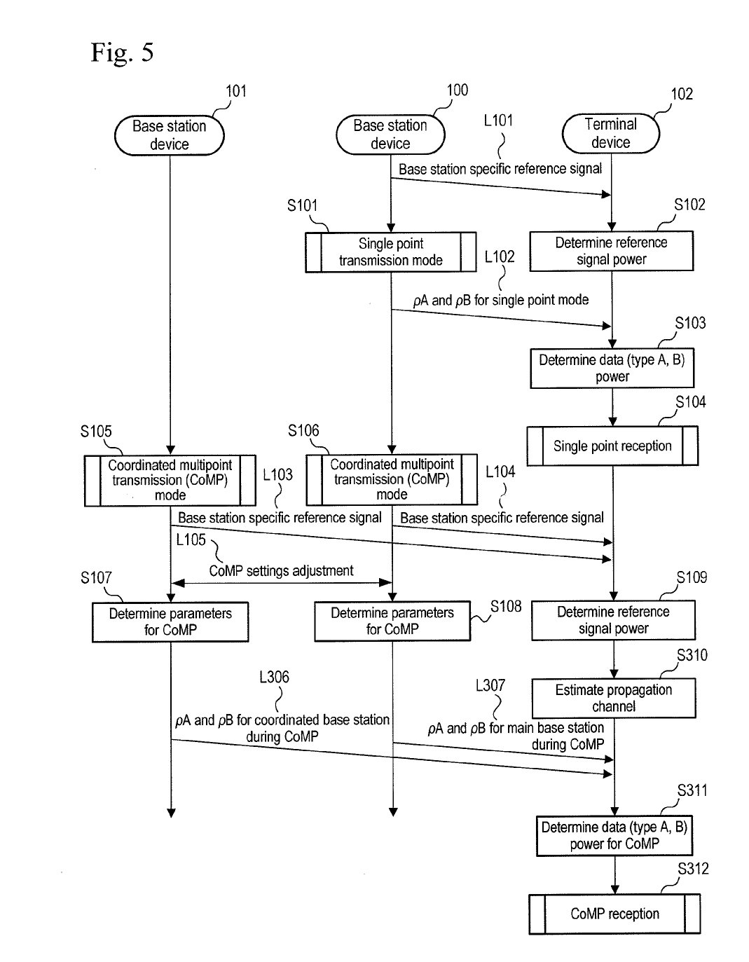

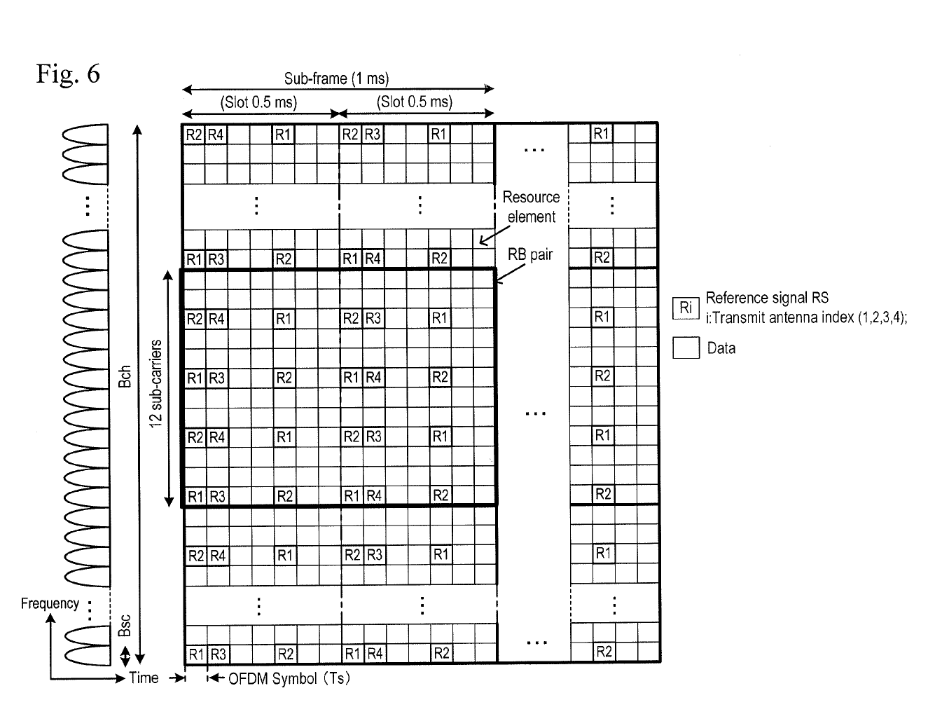

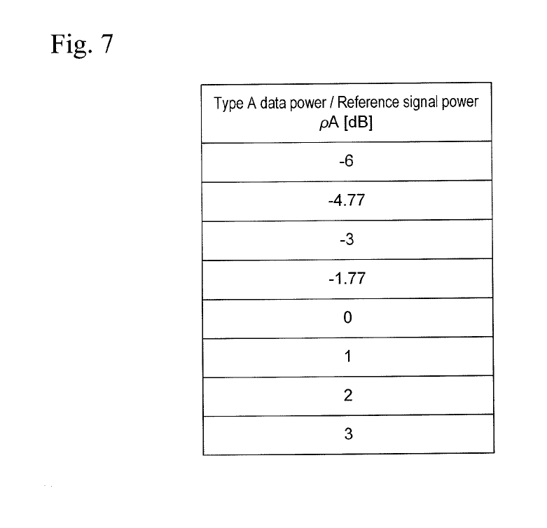

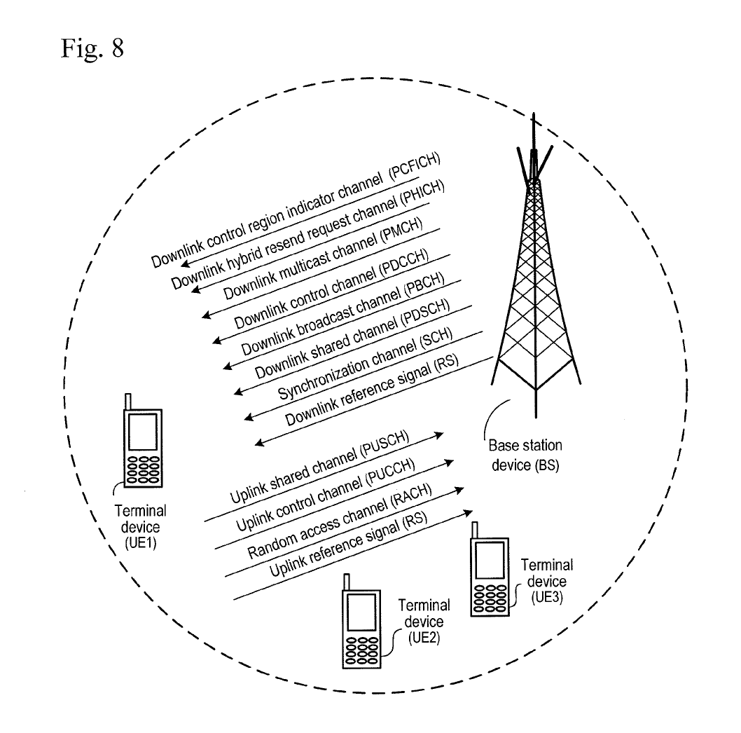

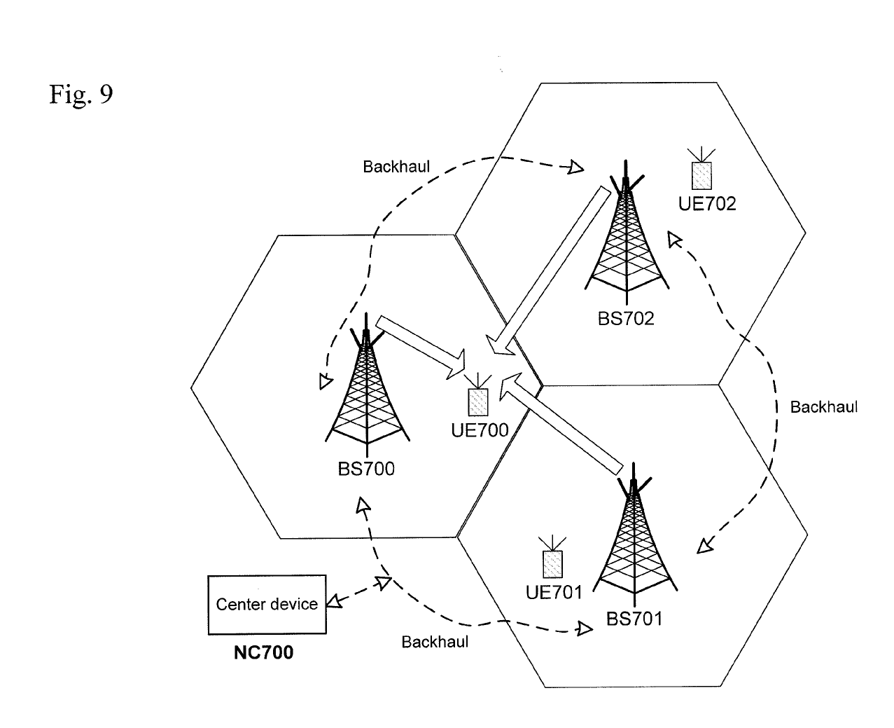

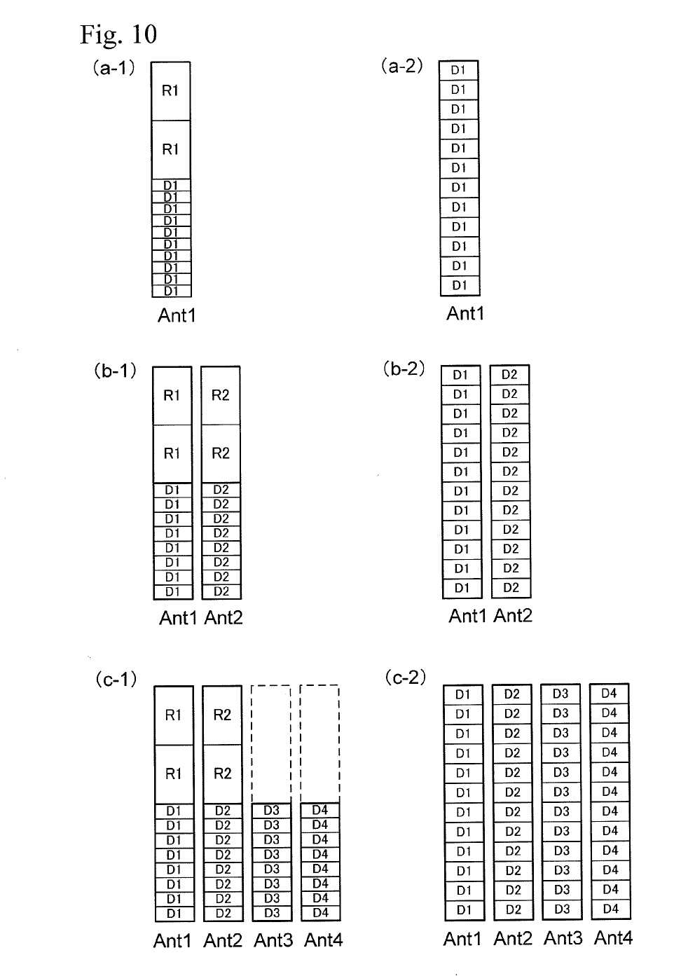

In the third embodiment of the present invention, instead of sending notifications of ρA and ρB for CoMP mode, the powers of type A and type B are all determined at the terminal device. In so doing, during CoMP mode, the same values of ρA and ρB may be defined for CoMP among the base station devices performing CoMP, or different values may be defined as well. In addition, each base station device may employ for CoMP, as is, the same ρA and ρB as when single point transmission is performed, or ρA and ρB of different values may be employed during CoMP. However, if the same values are not defined for ρA and ρB for CoMP, each base station device notifies the terminal device of its ρA and ρB. FIG. 5 is a flowchart representing one example of a power defining step with respect to a case where a notification of ρB for CoMP is not explicitly performed and where ρA and ρB are not defined as the same values for the CoMP at each base station device, which is the third embodiment of the present invention. In exchange for not defining ρA and ρB for CoMP as the same values from the base station devices to the terminal device, the ρA and ρB values for the main transmit base station device and the coordinated base station are respectively notified (L306, L307). If these ρA and ρB values are the same values as those for single point transmission, this notification may also be omitted. In addition, instead of individually performing this notification from each base station device, they may be transmitted collectively from one of the base station devices. The terminal device receives the reference signals from the respective base station devices 100 and 101 that perform COMP (L104, L103), and is able to find out the powers of the reference signals (S109). In addition, by performing propagation channel estimation based on the reference signals (S310), it is able to find out channel attenuation amount k1 between the base station device 100 and the terminal device 102, and channel attenuation amount k2 between the base station device 101 and the terminal device 102.

Assuming that the received powers of the received reference signals from the main base station device and the coordinated base station device are P′(R1) and P′(R2), respectively, that the ρA's of the main base station device and the coordinated transmitter device are ρA1 and ρA2, respectively, and that the ρB's of the main base station device and the coordinated base station device are ρB1 and ρB2, respectively, then the received data powers of type A and type B are:

Type A data power P″(Da)=P′(R1)×ρA1+P′(R2)33 ρA2

Type B data power P″(Db)=P′(R1)×ρA1×ρB1+P′(R2)×ρA2×ρB2

Here, assuming that the reference signal powers of the base station device 100 and the base station device 101 received at the terminal device are P′(R1) and P′(R2), respectively, since

reference signal power P′(R1)=P(R1)×k1

P′(R2)=P(R2)×k2

the terminal device is able to properly calculate the received data powers.

Thus, with respect to embodiments of the present invention, there is an advantage in that, even in cases where CoMP is performed at the base station devices, the terminal device is able to properly determine data powers without defining ρA and ρB for CoMP among the main base station device and the coordinated base station device.

It is noted that the embodiments above are not limited to the configurations, etc., shown in the appended drawings, and that modifications may be made as deemed appropriate so long as effects of the present invention are produced. In addition, implementation with modifications as deemed appropriate is possible so long as they do not depart from the scope of the objects of the present invention.

In addition, a program for realizing the functions described in the present embodiment may be recorded on a computer-readable recording medium, and a computer system may be made to read and execute the program recorded on this recording medium to perform the processes of the respective parts. It is noted that the term “computer system” as used herein is to encompass the OS, as well as hardware, such as peripheral devices, etc.

In addition, in cases where the WWW system is utilized, the term “computer system” is to encompass homepage providing environments (or displaying environments) as well.

In addition, the term “computer-readable recording medium” may refer to a portable medium, such as a flexible disk, a magneto-optical disk, ROM, CD-ROM, etc., or a storage device such as a hard disk, etc., built into a computer system. Further, the term “computer-readable recording medium” is also to encompass one that dynamically holds a program for a short period of time, as in communication lines in a case where a program is transmitted over a network, such as the Internet, etc., or communications lines, such as phone lines, etc., as well as one that holds a program for a given period of time, such as a volatile memory within a computer system that serves as a server or a client in such a case. In addition, the above-mentioned program may also be one for realizing a portion of the functions discussed above, and, further, it may also be one that is capable of realizing the functions discussed above in combination with a program(s) already recorded on a computer system.

### INDUSTRIAL APPLICABILITY

The present invention is applicable to communications devices.

All publications, patents and patent applications cited in the present specification are incorporated herein for reference in their entirety.

1. A base station device that communicates with a terminal device on its own or in coordination with another base station device, the base station device comprising:
indicating part that indicates the availability of the coordinated communication; and
a determining part that determines, in accordance with the availability of the coordinated communication, the ratio of the power of a data signal with respect to a transmission symbol including a reference signal to the power of a data signal with respect to a transmission symbol not including a reference signal.

2. The base station device according to claim 1, further comprising a transmitting part that transmits, to the terminal device, information indicating the ratio of the power of the data signal with respect to the transmission symbol including the reference signal to the power of the data signal with respect to the transmission symbol not including the reference signal.

3. A terminal device that communicates with a base station device that is coordinated with another base station device, the terminal device comprising a receiving part that receives, from the base station device, information indicating the ratio of the power of a data signal with respect to a transmission symbol including a reference signal to the power of a data signal with respect to a transmission symbol not including the reference signal.

4. A radio communication system in which coordinated multipoint transmission is performed among a plurality of base station devices and a terminal device, wherein, in a multi-carrier communication system in which communication is performed employing a transmission symbol including a reference signal and a transmission symbol not including a reference signal, a transmitter device of the base station devices comprises at least:
a communicating part that communicates with an inter-base station device network of the radio communication system;
an indicating part that indicates the availability of the coordinated multipoint transmission;
a determing part that determines the ratio of the power of a data signal with respect to the transmission symbol including the reference signal to the power of a data signal with respect to the transmission symbol not including the reference signal; and
a transmitting part that transmits each of information of the power of the data signal with respect to the transmission symbol including the reference signal and the power of the data signal with respect to the transmission symbol not including the reference signal, and wherein
the determining part performs each of power ratio definition for a case in which the coordinated multipoint transmission is not performed and power ratio definition for a case in which the coordinated multipoint transmission is performed, and determines the power ratio depending on the availability of the coordinated multipoint transmission.

5. The radio communication system according to claim 4, wherein, when performing the coordinated multipoint transmission, the radio communication system defines the ratio of the power of the data signal with respect to the transmission symbol including the reference signal to the power of the data signal with respect to the transmission symbol not including the reference signal to be the same value among the base station devices that perform the coordinated multipoint transmission.

6. The radio communication system according to claim 4, wherein, when performing the coordinated multipoint transmission, the base station devices define the ratio of the power of the data signal with respect to the transmission symbol including the reference signal to the power of the data signal with respect to the transmission symbol not including the reference signal to be the same value among the base stations that perform the coordinated multipoint transmission, and notify the terminal device of the ratio of the power of the data signal with respect to the transmission symbol not including the reference signal to the power of the reference signal.

7. The radio communication system according to claim 4, wherein the base station devices notify the terminal device of each of in an individual manner, the power ratio definition for a case in which the coordinated multipoint transmission is not performed and the power ratio definition for a case in which the coordinated multipoint transmission is performed.

8. A base station device in a multi-carrier communication system in which communication is performed employing a transmission symbol including a reference signal and a transmission symbol not including a reference signal, and which is a radio communication system in which coordinated multipoint transmission is performed among a plurality of base station devices and a terminal device, wherein a transmitter device of the base station device comprises at least:
a communicating part that communicates with an inter-base station device network of the radio communication system;
an indicating part that indicates the availability of the coordinated multipoint transmission;
a determining part that determines the ratio of the power of a data signal with respect to the transmission symbol including the reference signal to the power of a data signal with respect to the transmission symbol not including the reference signal; and
a transmitting part that transmits each of information of the power of the data signal with respect to the transmission symbol including the reference signal and the power of the data signal with respect to the transmission symbol not including the reference signal, and wherein
the determining part performs each of power ratio definition for a case in which the coordinated multipoint transmission is not performed and power ratio definition for a case in which the coordinated multipoint transmission is performed, and determines the power ratio depending on the availability of the coordinated multipoint transmission.

9. The base station device according to claim 8, wherein, when performing the coordinated multipoint transmission, the ratio of the power of the data signal with respect to the transmission symbol including the reference signal to the power of the data signal with respect to the transmission symbol not including the reference signal is defined to be the same value among the base station devices performing the coordinated multipoint transmission.

10. The base station device according to claim 8, wherein, when performing the coordinated multipoint transmission, the ratio of the power of the data signal with respect to the transmission symbol including the reference signal to the power of the data signal with respect to the transmission symbol not including the reference signal is defined to be the same value among the base stations performing the coordinated multipoint transmission, and the ratio of the power of the data signal with respect to the transmission symbol not including the reference signal to the power of the reference signal is notified to the terminal device.

11. The base station device according to claim 8, wherein the power ratio definition for a case in which the coordinated multipoint transmission is not performed and the power ratio definition for a case in which the coordinated multipoint transmission is performed are each individually notified to the terminal device.

12. A radio communication system in which coordinated multipoint transmission is performed among at least a plurality of base station devices and a terminal device, wherein, in a multi-carrier communication system in which communication is performed employing a transmission symbol including a reference signal and a transmission symbol not including a reference signal, a transmitter device of the base station devices comprises at least:
a communicating part that communicates with an inter-base station network of the radio communication system;
an indicating part that indicates the availability of the coordinated multipoint transmission;
a determining part that determines the ratio of the power of a data signal with respect to the transmission symbol including the reference signal to the power of a data signal with respect to the transmission symbol not including the reference signal; and
a transmitting part that transmits each of information of the power of the data signal with respect to the transmission symbol including the reference signal and the power of the data signal with respect to the transmission symbol not including the reference signal, and wherein
a receiver device of the terminal device is a terminal device that comprises at least:
a first receiving part that receives a reference signal of each base station device performing the coordinated multipoint transmission;
a channel estimation part that performs propagation channel estimation of from each base station device to the terminal device;
a second receiving part that receives information of, with respect to each base station device, the ratio of the power of the data signal with respect to the transmission symbol including the reference signal to the power of the data signal with respect to the transmission symbol not including the reference signal; and
a calculating part that calculates a received data power of when the coordinated multipoint transmission is performed.

13. A radio communication system in which coordinated multipoint transmission is performed among at least a plurality of base station devices and a terminal device, wherein, in a multi-carrier communication system in which communication is performed employing a transmission symbol including a reference signal and a transmission symbol not including a reference signal, a transmitter device of the base station devices is a terminal device employed in the multi-carrier communication system and comprising at least:
a communicating part that communicates with an inter-base station network of the radio communication system;
an indicating part that indicates the availability of the coordinated multipoint transmission;
a determining part that determines the ratio of the power of a data signal with respect to the transmission symbol including the reference signal to the power of a data signal with respect to the transmission symbol not including the reference signal; and
a transmitting part that transmits each of information of the power of the data signal with respect to the transmission symbol including the reference signal and the power of the data signal with respect to the transmission symbol not including the reference signal, and wherein
a receiver device of the terminal device is a terminal device that comprises at least:
a first receiving part that receives a reference signal of each base station device performing the coordinated multipoint transmission;
a channel estimation part that performs propagation channel estimation of from each base station device to the terminal device;
a second receiving part that receives information of, with respect to each base station device, the ratio of the power of the data signal with respect to the transmission symbol including the reference signal to the power of the data signal with respect to the transmission symbol not including the reference signal;
a third receiving part that receives power ratio information of, with respect to each base station device, the power of the reference signal to the power of the data signal with respect to the transmission symbol not including the reference signal; and
a calculating part that calculates a received data power of when the coordinated multipoint transmission is performed.

14. A transmission method for a base station device which is a multi-carrier communication method in which communication is performed employing a transmission symbol including a reference signal and a transmission symbol not including a reference signal in a radio communication system in which coordinated multipoint transmission is performed among a plurality of base station devices and a terminal device, comprising:
a step of transmitting, to the terminal device, information of the ratio during single point transmission of the power of the reference signal with respect to the transmission symbol including the reference signal to the power of a data signal with respect to the transmission symbol not including the reference signal, and information of the ratio during single point transmission of the power of a data signal with respect to the transmission symbol including the reference signal to the power of the data signal with respect to the transmission symbol not including the reference signal from the base station device to the terminal device;
a step of, when performing the coordinated multipoint transmission, defining the ratio during the coordinated multipoint transmission of the power of the reference signal with respect to the transmission symbol including the reference signal to the power of the data signal with respect to the transmission symbol not including the reference signal as well as the ratio during the coordinated multipoint transmission of the power of the data signal with respect to the transmission symbol including the reference signal to the power of the data signal with respect to the transmission symbol not including the reference signal to be the same values among the base station devices;
a step of transmitting, of during the coordinated multipoint transmission, information of the ratio of the power of the reference signal with respect to the transmission symbol including the reference signal to the power of the data signal with respect to the transmission symbol not including the reference signal and information of the ratio of the power of the data signal with respect to the transmission symbol including the reference signal to the power of the data signal with respect to the transmission symbol not including the reference signal to the terminal device; and
a step of switching, in accordance with the availability of the coordinated multipoint transmission, the ratio of the power of the reference signal with respect to the transmission symbol including the reference signal to the power of the data signal with respect to the transmission symbol not including the reference signal, as well as the ratio of the power of the data signal with respect to the transmission symbol including the reference signal to the power of the data signal with respect to the transmission symbol not including the reference signal.

15. A transmission method for a base station device which is a multi-carrier communication method in which communication is performed employing a transmission symbol including a reference signal and a transmission symbol not including a reference signal in a radio communication system in which coordinated multipoint transmission is performed among a plurality of base station devices and a terminal device, comprising:
a step of transmitting, to the terminal device, information of the ratio during single point transmission of the power of the reference signal with respect to the transmission symbol including the reference signal to the power of a data signal with respect to the transmission symbol not including the reference signal, and information of the ratio during single point transmission of the power of a data signal with respect to the transmission symbol including the reference signal to the power of the data signal with respect to the transmission symbol not including the reference signal from the base station device to the terminal device;
a step of, when performing the coordinated multipoint transmission, defining the ratio during the coordinated multipoint transmission of the power of the reference signal with respect to the transmission symbol including the reference signal to the power of the data signal with respect to the transmission symbol not including the reference signal as well as the ratio during the coordinated multipoint transmission of the power of the data signal with respect to the transmission symbol including the reference signal to the power of the data signal with respect to the transmission symbol not including the reference signal to be the same values among the base station devices;
a step of transmitting, to the terminal device, information of the ratio during the coordinated multipoint transmission of the power of the reference signal with respect to the transmission symbol including the reference signal to the power of the data signal with respect to the transmission symbol not including the reference signal as a value for coordinated multipoint transmission; and
a step of switching, in accordance with the availability of coordinated point transmission, the ratio of the power of the reference signal with respect to the transmission symbol including the reference signal to the power of the data signal with respect to the transmission symbol not including the reference signal, as well as the ratio of the power of the data signal with respect to the transmission symbol including the reference signal to the power of the data signal with respect to the transmission symbol not including the reference signal.

16. A reception method for a terminal device which is a multi-carrier communication method in which communication is performed employing a transmission symbol including a reference signal and a transmission symbol not including a reference signal in a radio communication system in which coordinated multipoint transmission is performed among a plurality of base station devices and the terminal device, comprising:
a step in which the terminal device receives a base station specific reference signal per base station device performing the coordinated multipoint transmission;
a step of calculating a channel attenuation amount between each base station device and the terminal device based on the received base station specific reference signal per base station device;
a step of receiving, per base station device, information of the ratio of the power of the reference signal with respect to the transmission symbol including the reference signal to the power of a data signal with respect to the transmission symbol not including the reference signal, as well as information of the ratio of the power of a data signal with respect to the transmission symbol including the reference signal to the power of the data signal with respect to the transmission symbol not including the reference signal; and
a step of calculating the power of a reception data signal based on the base station specific reference signal per base station device, the calculated channel attenuation amounts between the base station devices and the terminal device, the received information of the ratio of the power of the reference signal with respect to the transmission symbol including the reference signal to the power of the data signal with respect to the transmission symbol not including the reference signal, and the information of the ratio of the power of the data signal with respect to the transmission symbol including the reference signal to the power of the data signal with respect to the transmission symbol not including the reference signal.

17. A program for causing a computer to execute the transmission/reception method according to claim 14.

18. A computer-readable recording medium on which the program according to claim 17 is recorded.
